(19) United States
(12) Patent Application Publication
(10) Pub. No.: US 2013/0166420 A1
(43) Pub. Date: Jun. 27, 2013

(54) ENTERPRISE INVENTORY ASSET CONTROL WITH TRANSACTION STACKER

(71) Applicants: Brenda K. Holder, Tomball, TX (US); Sharleen Decelles, Langdon (CA)

(72) Inventors: Brenda K. Holder, Tomball, TX (US); Sharleen Decelles, Langdon (CA)

(73) Assignee: Fluor Technologies Corporation, Aliso Viejo, CA (US)

(21) Appl. No.: 13/336,300

(22) Filed: Dec. 23, 2011

(51) Int. Cl. G06Q 10/08

(52) U.S. Cl. 705/28

(57) ABSTRACT

Systems and methods for managing inventory life cycles are described, in which first and second transactions that correspond to distinct first and second assets, respectively, are analyzed based at least in part upon at least one lifecycle map having a series of lifecycle points. Each of the transactions can be mapped to a lifecycle point of the lifecycle map, and can be stored as a function of its associated lifecycle point.

### FIELD OF THE INVENTION

The field of the invention is inventory management systems and methods.

### BACKGROUND

Although there are various tools in the art for managing inventory, such tools are limited to tracking movement or disposition of assets. Exemplary tools are described in U.S. pat. publ. no. 2005/0216757 to Gardner (publ. September 2005); U.S. pat. publ. no. 2006/00747 to Capotosto et al. (publ. April 2006); U.S. pat. publ. no. 2006/0200477 to Barrenechea (publ. September 2006); and WIPO pat. publ. no. 2004/102323 to Swan, et al. (publ. November 2004). Typically, such tools update a chronological record associated with the asset when an event occurs (e.g., movement of asset, disposition, etc.).

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Although tools exist that can help provide further information about what assets are deployed (e.g., Tivoli™, SMS™, Radia™, etc.), such tools fail to assist with a full lifecycle tracking of assets. In addition, such tools fail to provide lifecycle sequencing of transactions based on a lifecycle model. Instead, several tools are generally required to track asset movement within an organization including, for example, provisioning tools to submit a request, IT service management tools used to manage installations, transfers, additions, and modifications, and IT asset inventory repositories to log final dispositions of assets. Adding to the complexity, there are typically many people across multiple groups and sometimes multiple organizations involved in the movement of assets from installation to final disposition.

Typically, asset information is updated sequentially by the various groups involved based on workflow routing of the updates, which heavily depends on close workflow and hand offs between the various groups and tools to achieve an understanding of an asset's current disposition. Because such tools require sequential updating of asset records, people involved in asset management and tracking are often waiting on others to enter their updates to asset information before they can enter their updates. This can lead to lengthy delays in discovering an asset's current status. Further compounding the problem, when updates are entered out-of- sequence, obsolete asset information may overwrite newer asset information.

Although known tools provide some benefit in tracking and managing inventory, all of the tools known to Applicants suffer from one or more disadvantages including, for example, data inconsistency, increased opportunity for human errors due to multiple data entries, delays in delivery of assets to end users due to tool update/workflow dependencies, limited visibility into assets that are available for redeployment, incomplete pictures about where assets are at any given time, significant time required to reconcile discrepancies among events, inadvertent overwrites of an asset's current status with a previous status because of illogical time/date sequencing, and heavily rely on workflow management. These problems only grow for larger organizations, where assets must be managed around the world across a large number of people from various workgroups.

Thus, there is still a need for inventory management systems and methods in which transactions are logically sorted as a function of a lifecycle map.

### SUMMARY OF THE INVENTION

The inventive subject matter provides apparatus, systems and methods in which one can manage inventory life cycles. Rather than rely heavily on workflow management, the inventive subject matter utilizes a logical lifecycle management, which advantageously reduces or eliminates the various problems discussed above.

A preferred method includes providing a lifecycle template database storing at least one lifecycle map having a series of lifecycle points. First and second transactions can be received that correspond to distinct first and second inventory assets, respectively.

Contemplated systems and methods can analyze each of the first and second transactions based at least in part upon the at least one lifecycle map. Based on this analysis, the first and second transactions can each be (a) mapped to at least one of first and second lifecycle points in the series of lifecycle points, and (b) stored in a transaction database as a function of its associated lifecycle point.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIGS. 1-2B are flowcharts of various embodiments of methods for managing an inventory life cycle.

FIG. 3 is one embodiment of a lifecycle map.

FIG. 4 is one embodiment of an inventory control and management system.

FIG. 5 is one embodiment of a transaction stacker engine.

FIG. 6 is one embodiment of a user interface.

### DETAILED DESCRIPTION

It should be noted that while the following description is drawn to computer/server based inventory management systems and methods, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus.

In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including providing near “real time” visibility into the disposition of all an organization's assets, which is useful to (1) facilitate rapid movement of assets associated with an increased volume of onboarding or offboarding, mobilization or demobilization, and break or fix activity of computers and other assets, (2) provide an increased focus on efficiently managing assets to reduce or eliminate unnecessary purchases, and (3) provide visibility into trends to facilitate forecasting capabilities.

In addition, the systems and methods described herein can provide more accurate and timely information concerning a status and current disposition of one or more inventory assets. This knowledge is essential to minimize unnecessary expenses that might otherwise be incurred as a result of the rapid movement of computers and other inventory assets, as well as related maintenance activities. In addition, contemplated systems and methods permit an organization to quickly be apprised of asset availability that may be needed for new hires, transfers, new projects, or to replace failed equipment.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

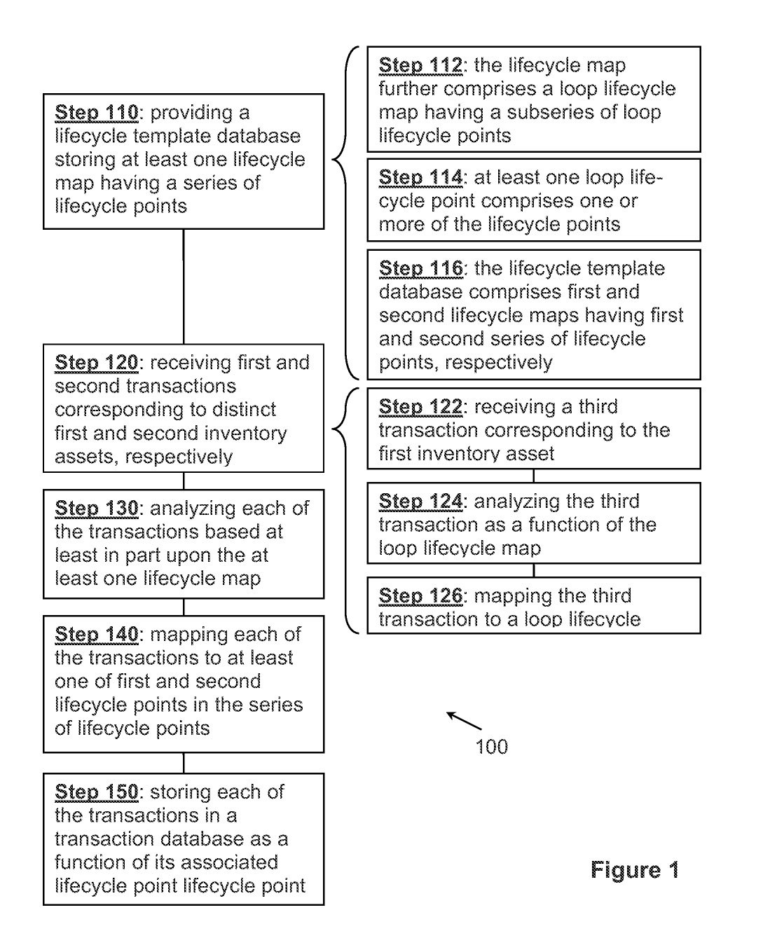

In FIG. 1, a method 100 of managing an inventory life cycle is shown that includes providing a lifecycle template database in step 110 capable of storing at least one lifecycle map having a series of lifecycle points.

Preferably, first and second transactions are received in step 120 that correspond to distinct first and second inventory assets, respectively. The inventory assets could include any assets typically managed by commercial inventory software including, for example, laptops, desktops, tablets, servers and other computers and their components, projectors, monitors, printers, scanners, and other computer peripherals, fax machines, televisions, cameras, cellular, VOIP and landline telephones, cars, trucks, boats and other vehicles, heavy equipment, weapons, radios, and so forth.

Contemplated transactions can include, for example, available, deskside, pending disposal, disposed, transferred, reserved, in use, quarantined, and in repair.

Each of the transactions can be analyzed in step 130 based at least in part upon information associated with the transaction and the at least one lifecycle map. Depending upon the analysis, each of the transactions can be mapped to a specific lifecycle point of a lifecycle map. For example, the first and second transactions could each be mapped in step 140 to points in separate lifecycle maps, or alternatively, could each be mapped to points in the same lifecycle map. In such circumstances, it is contemplated that each of the transaction could be mapped to the same or different points of the lifecycle map depending upon the information associated with the transaction. For example, a set of twenty identical new computers could be received that produces twenty individual transactions for analysis. Because each of the assets is currently at the same point in its lifecycle, the twenty transactions would likely each be mapped to the same point of a lifecycle map.

It is further contemplated that a single transaction could include information about multiple assets, especially where the assets are associated with the same lifecycle map. Thus, in the example above, a single transaction could include information about some or all of the twenty computers.

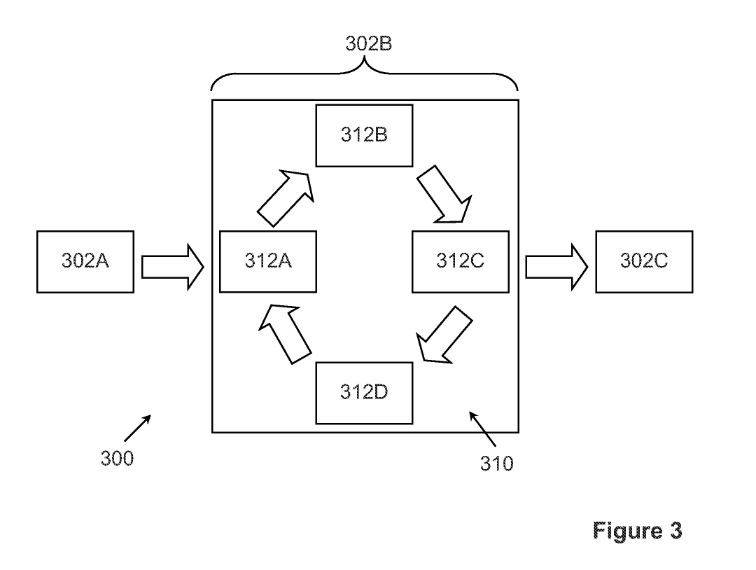

The at least one lifecycle map can include a loop lifecycle map in step 112 that has a subseries of loop lifecycle points. An exemplary embodiment of a loop lifecycle map is shown in FIG. 3. In some contemplated embodiments, at least one of the loop lifecycle points, and preferably the series of loop lifecycle points, can comprise one or more of the lifecycle points (step 114). Thus, for example, if lifecycle map comprises lifecycle points A-G, lifecycle point D might comprise the loop lifecycle map. In such example, while the asset is associated with a loop lifecycle point, the asset would also be associated with lifecycle point D.

In contrast to the lifecycle points of a lifecycle map, it is contemplated that an inventory asset could be associated with one or more of the loop lifecycle points multiple times. Thus, for example, an asset may be associated with each of the loop lifecycle points at least twice before the asset is associated with a lifecycle point subsequent to the series of loop lifecycle points, and thereby “exits” the loop.

It is contemplated in step 116 that the lifecycle template database can include first and second lifecycle maps, which have first and second series of lifecycle points, respectively. Thus, for example, the first lifecycle map may be associated with a first type of assets (e.g., computers), while the second lifecycle map may be associated with a second type of assets (e.g., vehicles). Of course, it is also contemplated that multiple lifecycle maps could be associated with a single type of assets. In addition, multiple types of assets could be associated with a single lifecycle map.

In step 122, a third transaction can be received corresponding to the first inventory asset. The third transaction can be analyzed in step 124 as a function of the loop lifecycle map and can be mapped in step 126 to a loop lifecycle point as a function of the analysis.

In step 150, each of the transactions can be stored in a transaction database as a function of its associated lifecycle point.

Thus, regardless of the timing and order in which transactions associated with an inventory asset are received, the transactions can be properly ordered and stored by matching each transaction to a lifecycle point in a lifecycle map.

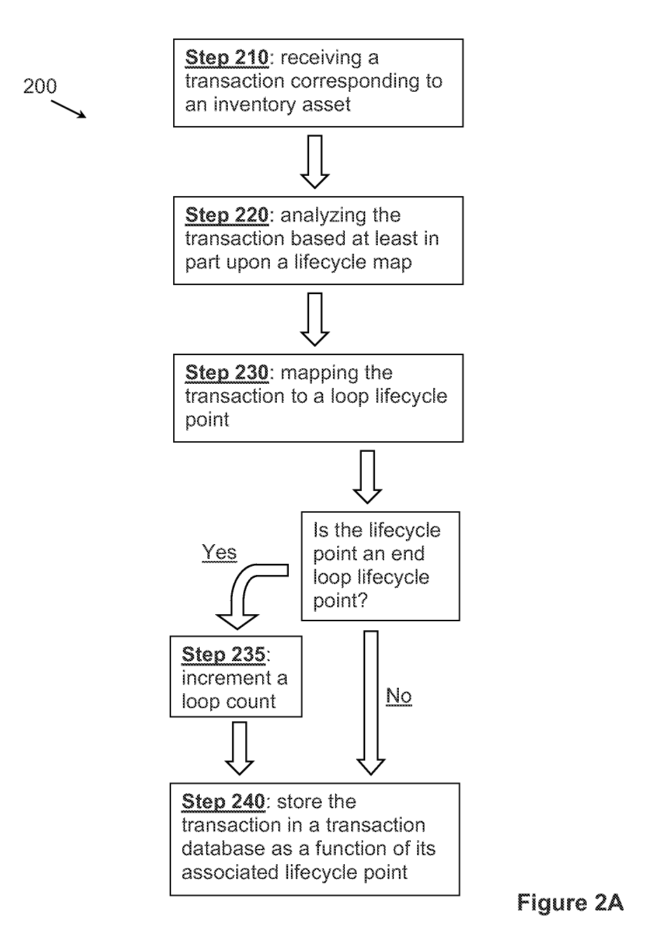

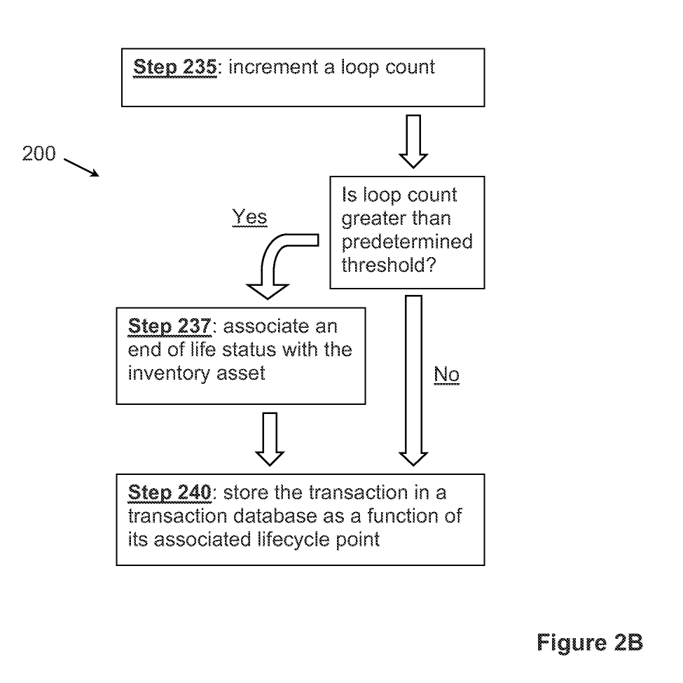

FIGS. 2A-2B illustrate a flowchart of one method 200 of mapping a transaction to a loop lifecycle point. In step 210, a transaction is received corresponding to an inventory asset. The transaction can be analyzed in step 220 based at least in part upon a lifecycle map. From this analysis, the transaction can be mapped or otherwise associated to a loop lifecycle point of a loop lifecycle map in step 230. In step 240, the transaction can then be stored in a transaction database as a function of its associated lifecycle point.

In some contemplated embodiments illustrated in FIG. 2A, method 200 can include a loop count, which monitors the number of times an asset has been associated with all of the loop lifecycle points of a loop lifecycle map (i.e., “completed” the loop). In such embodiments, when the transaction is mapped to a loop lifecycle point, a counter engine can check to see if the associated lifecycle point is an end loop lifecycle point. If so, a loop count can be incremented by the counter engine or other component in step 235. The transaction including an associated loop count can then be stored in a transaction database in step 240 as a function of its associated lifecycle point. In this manner, the system can track the number of times each asset has cycled through the loop.

As shown in FIG. 2B, after the loop count is incremented in step 235, it is further contemplated that the counter engine or other component can check to see if the loop count is greater than a predetermined threshold by comparing the loop count with the threshold. If the loop count is greater than the predetermined threshold, an end of life status can be associated with the inventory asset in step 237. The transaction can then be stored in a transaction database in step 240 as a function of its associated lifecycle point. This advantageously allows a user to at any time determine how many times an asset has repeated the loop lifecycle map, and the user can set a threshold to automatically determine when the asset should reach end of life disposition.

In some contemplated embodiments, the threshold may be based upon previous data associated with the same or similar types of assets. For example, the threshold could be based upon historical data for an inventory asset type to maximize the number of times an asset repeats the loop lifecycle map prior to being disposed.

FIG. 3 illustrates an embodiment of a lifecycle map 300 that includes a series of lifecycle points 302A, 302B, and 302C. The lifecycle map 300 can also include a loop lifecycle map 310 having a series of loop lifecycle points 312A, 312B, 312C, and 312D. In preferred embodiments, the loop lifecycle map is part of the lifecycle map, and in this example, is incorporated into lifecycle point 302B. Thus, in such example, while an inventory asset is associated with one or more of the loop lifecycle points 312A, 312B, 312C, and 312D, the inventory asset would also be associated with the lifecycle point 302B.

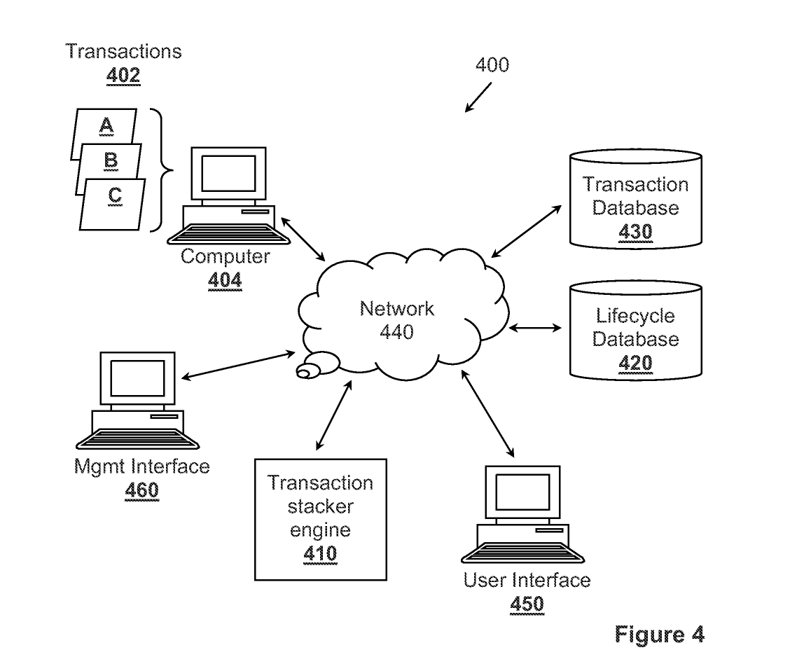

In FIG. 4, an inventory activity control and management system 400 is shown for managing life cycles of inventory assets. The system 400 can include a transaction stacker engine 410 configured to receive a plurality of transactions 402A-402N, each of which can be associated with one or more inventory assets. The transactions 402A-402N can each be received over a network 440 from a computer 404, RFID reader, or any other commercially suitable device. It is further contemplated that the transaction stacker engine 410 may receive transactions from a plurality of computers or other devices disposed in disparate locations.

Each of the transactions 402A-402N can include information regarding one or more inventory assets. Such information could comprise various attributes of one or more inventory assets including, for example, identifying numbers or other information, class(es) or subclass(es) of goods, location information, status (e.g., working/not working), current dispositions (e.g., in use/not in use), previous dispositions, transaction dates, warranty information, initial receipt dates, and loop counts.

System 400 can further include a lifecycle database 420 configured to store at least one lifecycle map having a series of lifecycle points.

The transaction stacker engine 410 can be further configured to analyze the received transactions 402A-402N, and logically “stack” each of the transactions 402A-402N as a function of at least one lifecycle map. Thus, for example, the transaction stacker engine 410 can map each of the transactions 402A-402N to one or more lifecycle points based upon information associated with each transaction. In this manner, regardless of (a) the order in which the transactions 402A-402N are received and (b) the date and time associated with the transaction, the transactions 402A-402N will be properly ordered (stacked) by the transaction stacker engine 410 according to the one or more lifecycle maps. Such analysis advantageously eliminates workflow dependent sequencing and reliance on the transaction's time stamp that is common with prior art systems.

It is contemplated that the transaction stacker engine 410 could process the received transactions 402A-402N on a daily, hourly, or other periodic basis, or as they are received. In such embodiments where the engine 410 processes received transactions on a periodic basis, it is contemplated that the received transactions could be stored, at least temporarily, in a transaction database 430 or other suitable database.

In some contemplated embodiments, the received transactions can first be processed by a pre-processor engine (not shown) configured to analyze the received transactions and thereby check for various errors including, for example, missing information and duplicate entries. If errors are detected, such transactions can be flagged, and the flagged transactions can be transmitted back to the user for editing.

System 400 can advantageously remove inventory asset management dependencies on workflow processes and handoffs between multiple groups involved in inventory asset movement to understand the last known disposition of an inventory asset.

The processed transactions can be stored in a transaction database 440, such that system 400 can advantageously maintain a historical log of the transactions that can be useful in locating a missing inventory asset. For example, system 400 could include a user interface 450 that can be configured to graphically display one or more transaction as a function of a lifecycle map. In this manner, the user interface 450 can be used to examine past transactions associated with an inventory asset to thereby determine a last known location and disposition of an inventory asset.

System 400 could also include a management interface 460 configured to allow a user to edit, delete, or otherwise manage the received transactions 402A-402N, or input additional transactions. For example, management interface 460 could be configured such that a user can edit one or more transactions to correct errors, eliminate duplicate transactions, or address other issues that may arise. Although user interface 450 and management interface 460 are shown as separate interfaces, it is contemplated that the interfaces 450 and 460 could comprise a single interface.

In other contemplated embodiments, management interface 460 can also be configured to provide various reporting capabilities including, for example, a transaction log for a specified time period (e.g., hourly, daily, weekly, monthly, etc.), a month end report that could be limited to reporting on various types of transactions including, for example, receipt of new inventory assets, movement of inventory assets, and disposal of inventory assets, and a service level report regarding the status of processing updates to the inventory assets.

Management interface 460 could be further configured to identify inventory assets that lack one or more transactions that should be associated with prior inventory points of a lifecycle map. For example, an inventory asset may have associated transactions that are mapped to lifecycle points A, B, and D, but lacks a transaction mapped to lifecycle point C. The management interface 460 can be used to identify such missing transactions, and thereby flag potential issues in inventory management such as faulty equipment, need for additional training, and so forth.

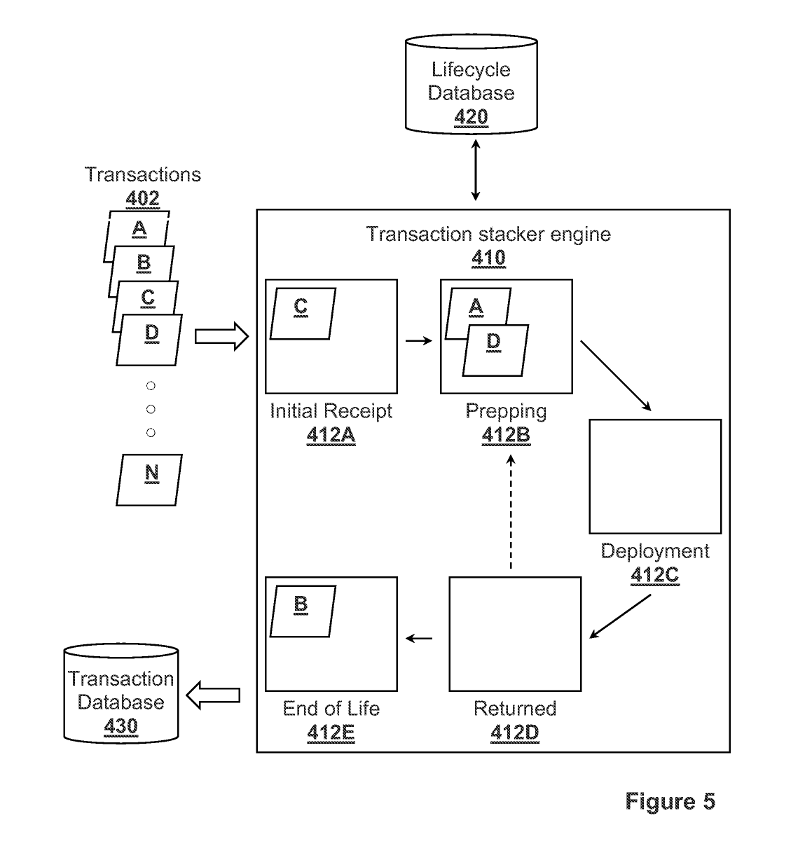

FIG. 5 illustrates one embodiment of a transaction stacker engine 410 configured to receive transactions 402A-402N and map the transactions 402A-402N to lifecycle points 412A-412E of a lifecycle map. With respect to the remaining numerals in FIG. 5, the same considerations for like components with like numerals of FIG. 4 apply.

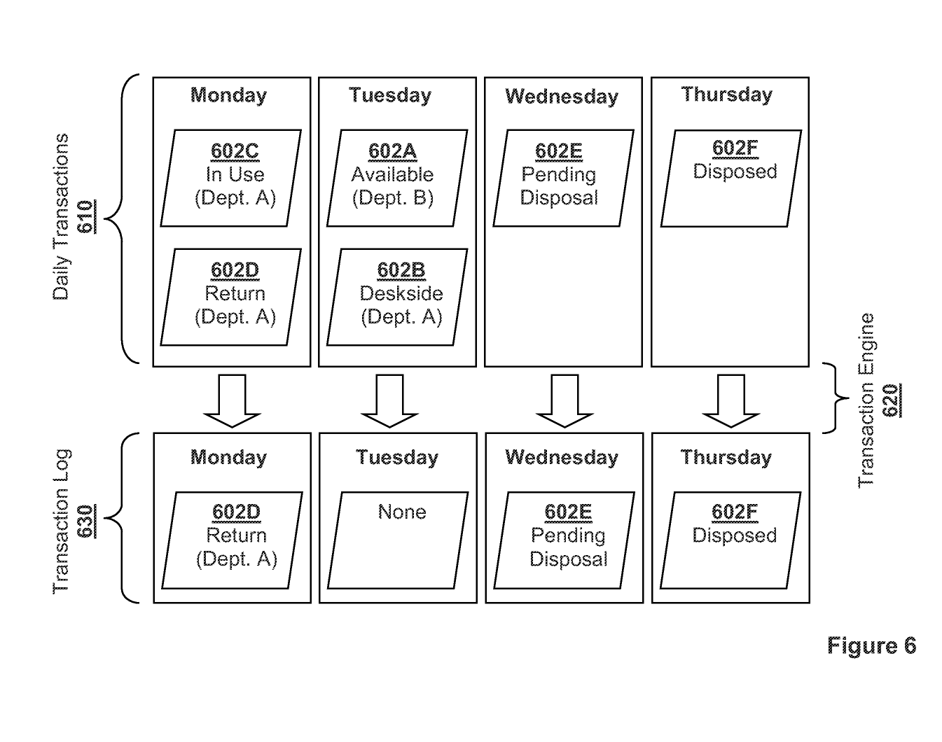

In FIG. 6, an example of a user interface 600 is shown that identifies daily and weekly received transactions 602A-602F for an inventory asset. A transaction stacker engine 620 is configured to analyze daily transactions 610, and stack each of the received transactions by comparing each transaction to a lifecycle map associated with the inventory asset.

For example, transactions 602C and 602D were received on Monday. The transaction engine 620 analyzes the transactions 602C-602D, and saves transaction 602D to a transaction log 630 because transaction 602D corresponds to a later lifecycle point than transaction 602C. On Tuesday, transactions 602A-602B are received. Neither of the transactions 602A-602B is saved to the transaction log 630 because both transactions are mapped to lifecycle points that are prior to the lifecycle point associated with transaction 602D. On Wednesday and Thursday, transactions 602E and 602F, respectively, are received and stored in transaction log 630.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . . and N, the text should be interpreted as requiring only one element from the group, not A plus N, or B plus N, etc.

What is claimed is:

1. A method for managing inventory life cycles, comprising:
providing a lifecycle template database storing at least one lifecycle map having a series of lifecycle points;
receiving first and second transactions corresponding to distinct first and second inventory assets, respectively;
analyzing each of the first and second transactions based at least in part upon the at least one lifecycle map;
mapping each of the first and second transactions to at least one of first and second lifecycle points in the series of lifecycle points; and
storing each of the first and second transactions in a transaction database as a function of its associated lifecycle point.

2. The method of claim 1, wherein the at least one lifecycle map further comprises a loop lifecycle map having a subseries of loop lifecycle points.

3. The method of claim 2, wherein at least one of the loop lifecycle points comprises one or more of the series of lifecycle points.

4. The method of claim 2, further comprising:
receiving a third transaction corresponding to the first inventory asset;
analyzing the third transaction as a function of the loop lifecycle map; and
mapping the third transaction to a loop lifecycle point.

5. The method of claim 4, wherein the subseries of loop lifecycle points comprises an end loop lifecycle point, and further comprising associating a loop count with the first inventory asset, and wherein the step of mapping the third transaction further comprises mapping the third transaction to the end loop lifecycle point and incrementing the loop count.

6. The method of claim 5, further comprising comparing the loop count with a predetermined threshold, and associating an end of life status with the first inventory asset if the loop count is greater than the predetermined threshold.

7. The method of claim 1, wherein the step of analyzing further comprises associating each of the first and second transactions to the first lifecycle point.

8. The method of claim 1, wherein the step of analyzing further comprises associating the first transaction to the first lifecycle point, and associating the second transaction to the second lifecycle point, and wherein the second lifecycle point is subsequent to the first lifecycle point in the series.

9. The method of claim 1, wherein the lifecycle template database comprises first and second lifecycle maps having first and second series of lifecycle points, respectively.

10. The method of claim 9, wherein the step of analyzing further comprises associating the first transaction to a lifecycle point of the first series, and associating the second transaction to a lifecycle point of the second series.

11. The method of claim 1, wherein the first inventory asset comprises at least one of a desktop computer, a monitor, a laptop computer, and a mobile phone.

12. The method of claim 1, further comprising:
receiving a third transaction corresponding to the first inventory asset;
analyzing the third transaction based at least in part upon the at least one lifecycle template, and associating (i) the third transaction to the first lifecycle point and (ii) the first transaction to the second lifecycle point.

13. The method of claim 1, wherein each of the first and second transactions comprises a transaction date attribute.

14. The method of claim 1, further comprising configuring a user interface to graphically display the first and second transactions as a function of the at least one lifecycle map.

15. The method of claim 1, further comprising providing a management interface configured to allow a user to manage the first and second transactions.
